(19) United States
(12) Patent Application Publication
(10) Pub. No.: US 2006/0271384 A1
(43) Pub. Date: Nov. 30, 2006

(54) Reference data aggregate service population

(75) Inventors: Ryan A. Munson, Fargo, ND (US); Jeffrey R. Anderson, West Fargo, ND (US); John A. Healy, West Fargo, ND (US); Josh W. Honeyman, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/140,712

(22) Filed: May 31, 2005

(51) Int. Cl. G06Q 99/00

(52) U.S. Cl. 705/1

(57) ABSTRACT

The present invention provides a method for registering a service with an aggregation service, and storing data within the aggregate service. The process of registration is performed by a service explicitly notifying or being discovered by the aggregation service. In one embodiment there are four steps to the registration process. The first step is determining existence of a service and there are two ways this can happen, discovery and explicit notification. The second step of the process is metadata retrieval. Once the existence of the service is determined, the aggregation service attempts to retrieve relevant metadata about the service. The third step is setting up how the aggregation service is populated. If it is to be populated via a push synchronization, entity create, update, and delete event subscriptions are created with the service so it will push its data to the aggregation service. If pull synchronization is used, a scheduled retrieval process is configured on the aggregation service so the service can pull data at scheduled intervals. The fourth step in the process is the initial population of the aggregation data store.

### BACKGROUND OF THE INVENTION

A service is a system that a consumer of the service interacts with through a set of coarse-grained messages. A service oriented application may be composed of one or more services. Each of these application services typically contains a set of entities. Entities, in general, encapsulate data and provide a rich programming model for reading, writing, updating and deleting the data owned by the service.

Services typically contain private data and public data. The private data is encapsulated in an internal entity so that, within the service, the programming model provides access to all of the data and associations contained in the internal entity, but external to the service, the internal entity is not exposed through the service interface. However, public data is encapsulated in a publicly available entity which is available to consumers of the service.

It is common for a consumer of a service to access data of an entity owned by the service. One prior way for enabling this had the consumer directly access the owning service's data store. However, a direct access to the owning service's data store requires the consumer of the data to have knowledge of the technology and table structure used by the owning service to store data in its data store. Similarly, such direct access allows the consumer to potentially view and change private data within the service. This is problematic for a number of reasons, and is discouraged in applications that honor the publicly known tenets of service orientation. These are set out in an article by Don Box entitled Code Name Indigo: A Guide to Developing and Running Connected Systems with Indigo, MSDN Magazine, January 2004. Basically, allowing an external service or client to bind directly to the owning service's data (either by access to the service's private entities or by directly accessing the data store which the service stores its data in) is a technique that compromises data integrity, the autonomy, and the explicit boundaries of the service in a service oriented environment. Instead, all communication with a service should occur using standardized message exchange.

In addition, many developers wish to develop systems in which the services are autonomous. Synchronizing and replicating data locally to the consumers of the service is often done to achieve such autonomy, because a given service does not then require the owning service to be available to retrieve data and process requests. However, a consumer may only be interested in a subset of the properties of the entity in the owning service.

In the past, in order to access only part of an entity, the consumer was required to have table-level access to the data in the owning service (which violates the tenets of service orientation as mentioned above), or it had to request the entire entity through the owning service's interface. Of course, an entity may have a very large number of properties (often in the hundreds) and a consumer may only require access to a very small number (such as five) of the properties. The consumer will normally not wish to incur all the overhead for processing such a large data set, when it only needs a small subset of the data.

This becomes even more important if functionality is provided to synchronize associated data to a local data store. For instance, a consumer may wish to periodically synchronize a subset of the data from the owning service's data store to its own local data store. The consumer's local data store may be remote from the owning service's data store and may even be on a laptop computer or other mobile device. If the consumer is required to synchronize unwanted properties of an entity, this can greatly increase the amount of time and processing overhead required to perform the synchronization process. Further, when bringing a consumer on line, the initial synchronization of data can become burdensome and consume undesirable amounts of time and processing overhead.

Services also typically expose a plurality of publicly available data contracts. The data contracts identify the publicly available entities and the properties contained within those entities and specify how the entities are associated or related. Upon being queried through an interface, the service will generally provide access to data in the publicly available data contracts to the requester.

In a service oriented system there is a need to have one service whose purpose is to serve as the single point for aggregating reference data from all other services in the system. To do so, the aggregation service needs a mechanism to discover these services and ultimately get up-to-date with the reference data that exists in each of those services.

### SUMMARY OF THE INVENTION

The present invention provides a method for registering a service with an aggregation service. The process of registration starts in one of two ways. In one embodiment, the service comes online with the aggregate service already running. In another, the service is already running, and the aggregate service comes online. At this point, the service is either detected by the aggregate service or contacts the aggregate service. In one embodiment, the service comes on line and the aggregate service is already running. In another embodiment, the service is already running and the aggregate service comes on line. The process of registration can occur either as a push type registration where the service pushes data to the aggregate service, or a pull type registration where the aggregate service pulls the data from the service. In one embodiment there are four steps to the registration process

The first step is determining existence of a service and there are two ways this can happen, discovery and explicit notification. Discovery is where the aggregate service queries the network to see if there are any new services online. Explicit notification is where the service sends a directed message to the aggregation service requesting that it be registered.

The second step of the process is metadata retrieval. Once the existence of the service is determined, the aggregation service attempts to retrieve relevant metadata about the service.

The third step is setting up how the aggregation service is populated. If it is to be populated via push synchronization; entity create, update, and delete event subscriptions are created with the service so it will push its data to the aggregation service. If pull synchronization is used, a scheduled retrieval process is configured on the aggregation service so the service can pull data at the scheduled time.

The fourth step in the process is the initial population of the aggregation data store. The process, by which this initial population occurs, is determined by whether the aggregation service is using a push or pull protocol.

### BRIEF DESCRIPTION OF THE DRAWINGS

FIG. 1 is a block diagram of one computing environment in which the present invention may be practiced.

FIG. 2 is a block diagram of two services, each with entities and public data contracts.

FIG. 3A illustrates a generation tool used for generating entity projections in accordance with one embodiment of the present invention.

FIG. 3B illustrates the tools shown in FIG. 3A interacting with additional services.

FIG. 4 is a flow diagram illustrating the operation of the tool shown in FIGS. 3A and 3B.

FIGS. 5A and 5B illustrate exemplary displays for allowing a user to create an entity projection from a public data contract.

FIG. 6 shows a more detailed embodiment of two services, their corresponding entities, and entity projections.

FIG. 7 is a block diagram illustrating how filters are applied to data that is synchronized from an aggregation service to a requester.

FIG. 8 is a flow diagram illustrating the steps executed during the registration of a service with an aggregation service.

FIG. 9 is a block diagram illustrating the relationship between the service and the aggregation service during registration.

FIG. 10 is a flow diagram illustrating the operation of the system shown in FIG. 7.

### DETAILED DESCRIPTION OF ILLUSTRATIVE EMBODIMENTS

The present invention deals with populating an aggregation service with data and metadata from an owning service such that the data can be used by one or more consumers of that data. The consumer may illustratively be a client, or another service. However, before describing the present invention in greater detail, one illustrative environment in which the present invention can be used will be described.

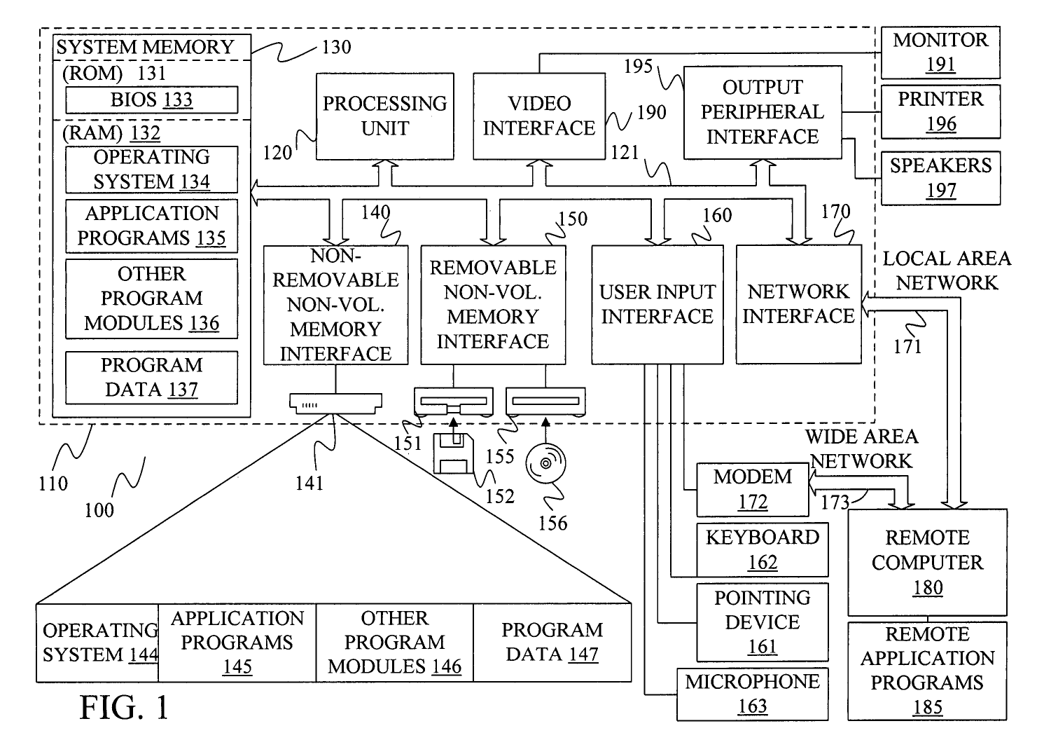

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

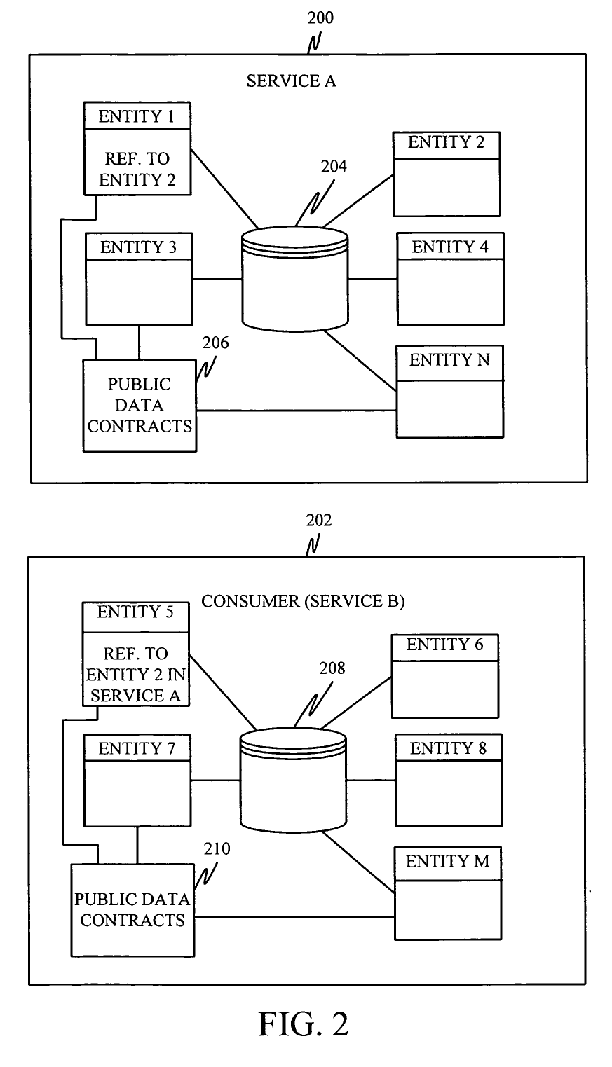

FIG. 2 is a block diagram of two autonomous services, service A represented by numeral 200 and service B represented by numeral 202. Service A is shown with a plurality of entities (entity 1-entity N) that are stored in a data store 204 that is local to service A. FIG. 2 also shows that service A includes one or more public data contracts 206 that represent the entities, how they are related, and the publicly available properties in each of those entities. There may illustratively be one data contract per entity. However, the data contracts could be arranged in other ways as well.

Service B also includes a plurality of entities (entity 5-entity M) that are stored in a data store 208 that is local to service B. FIG. 2 also shows that service B includes one or more public data contracts 210 that describe the entities, the relationships between the entities, and the publicly available properties for the entities found in service B. For the sake of the present discussion, service B is referred to as the consumer 202. That is because service B includes an entity (entity 5) that has a reference to data owned by service A. For instance, entity 5 in service B might consume data encapsulated by entity 2 owned by service A. Therefore, service B is designated as the consumer 202 because it consumes data owned by another service. It will of course be noted that by consumer it is meant a service, application, entity, or other component that requires access to data in another service.

In prior systems, in order for service B to access the data in service A, a number of different techniques could be used. In a first technique, service B would require direct association to the entity in service A and/or the data stored in data store 204 in service A. This would lead to a number of problems which are discussed in the background portion of this description. Alternatively, service B, could query service A for all of entity 2, even though service B was only interested in a subset of the properties of entity 2 in service A. This also leads to disadvantages described in the background.

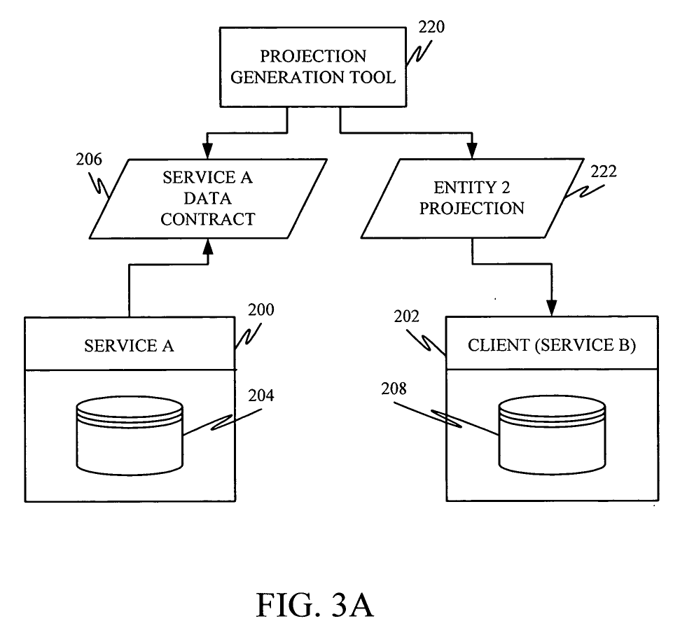

FIG. 3A shows that the present invention provides a projection generation tool 220 that accesses the public data contracts 206 from service A and creates an entity projection 222, from the information stored in one or more contracts 206, and provides entity projection 222 to service B. The entity projection 222 will be a local abstraction to service B, but contain only the properties of entity 2 (from service A) that are required, and those that are desired by entity 5 in service B.

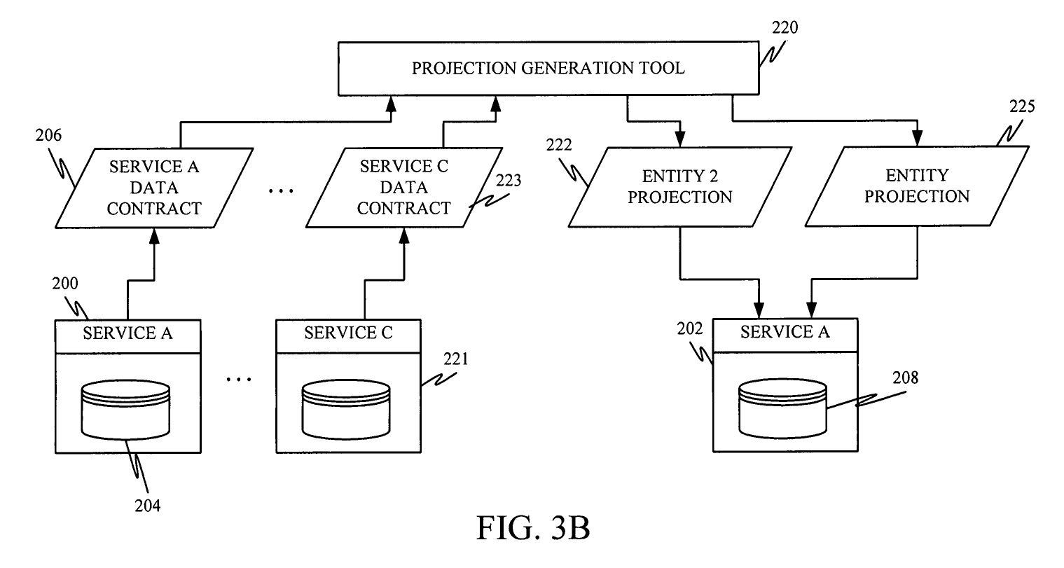

FIG. 4 is a flow diagram better illustrating the operation of the system shown in FIG. 3A. Tool 220 is illustratively configured to interact with services A and B through predetermined interfaces. In order to generate a projection, the present discussion will proceed with respect to entity 5 in service B requiring access to certain properties of entity 2 from service A. Therefore, tool 220 will generate an entity projection in service B of entity 2 from service A. Tool 220 initially queries service A for its public data contracts. This is indicated by block 300 in FIG. 4. Service A provides its data contracts 206 to tool 220, and tool 220 loads the data contracts. This is indicated by block 302 in FIG. 4.

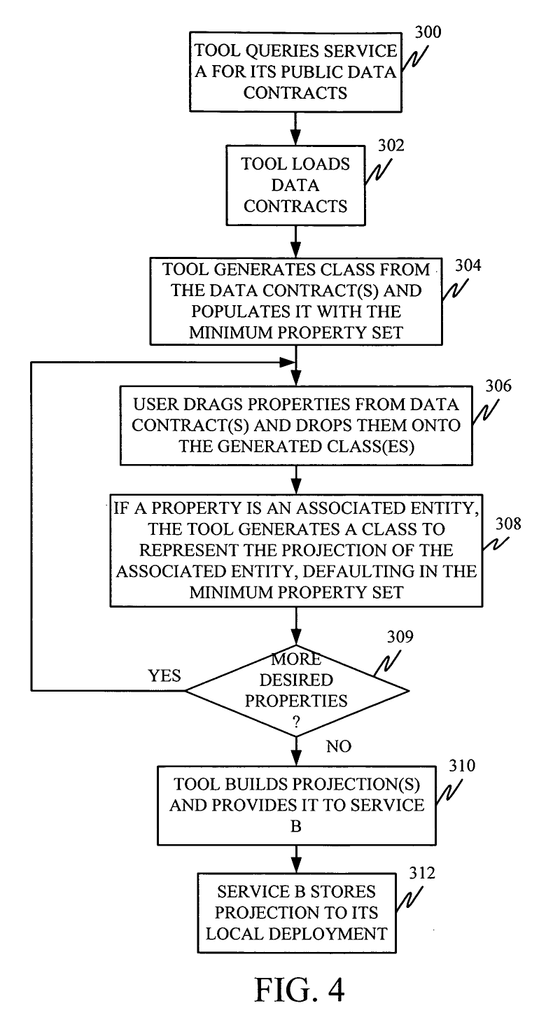

Tool 220 then illustratively generates a class containing only the required properties based on the information set out in the publicly available data contracts 206. The generated class corresponds to the entity for which the projection is to be generated. FIG. 5A illustrates one illustrative embodiment of an interface display 320 illustrating this. The generated class is illustrated at 322 on display 320, and generating the class from the data contract is indicated by block 304 in FIG. 4.

FIG. 5A also shows, on the left half of the display, that tool 220 displays a list of the publicly available properties in the public data contracts from the relevant entities in service A. This is indicated generally at 324 in FIG. 5A.

Once this display 320 is generated, the user can simply drag properties from list 324 onto the generated entity class 322 in order to populate the entity class 322 with the desired properties. This is indicated by block 306 in FIG. 4.

The entity projection is thus a read-only entity abstraction that can be generated from the data contract for an entity exposed by another service. The projection can include any number of properties exposed from the owning entity's contract, but will also contain the required fields (minimum set of properties) of the entity. The entity projections provide read functionality as does any other entity, but can be totally generated based on the data contract of another entity.

It will also be noted that projections can be generated from multiple different services, and compositions and associations can also be generated. For instance, FIG. 3B shows projection generation tool 220 generating entity projections for a consumer (service B) from not just a single service A, but from multiple services (service A and service C). The items that are similar to those shown in FIG. 3A are similarly numbered.

Service C shown in FIG. 3B is illustrated by numeral 221 and its publicly available data contracts are indicated by numeral 223. The entity projection from service C is indicated by numeral 225. Thus, service C makes its data contracts available to projection generation tool 220 which displays the publicly available properties in each data contract to the user. This is indicated by an illustrative display 400 shown in FIG. 5B. FIG. 5B illustrates that not only are the publicly available data contracts and publicly available properties for each contact from service A shown in list 324, but the publicly available data contracts and publicly available properties for each contract from service C are also shown in list 325.

FIG. 5B also shows that tool 220 has opened a plurality of generated classes. The first is class 322 which is described above. However, since service B illustratively requires data from service C, another generated entity projection 402 is opened by the tool and displayed to the user. Thus, the user can drag properties from lists 324 and 325 onto the generated classes 322 and 402, respectively.

It may also be that one of the properties dragged by the user may be an associated entity (i.e., an entity associated with the entity represented by a generated entity projection). For instance, if the user is populating the entity A projection 322 with properties, and the user drags a property that is actually an entity that is associated with entity A, then tool 220 generates a class for the associated entity projection and populates it with the minimum property set. In the illustrated embodiment, entity B is associated with entity A and therefore an entity B projection is generated. This is designated by numeral 404 in FIG. 5B. Generating an entity projection to represent the class of the associated entity is indicated by block 308 in FIG. 4. This can occur recursively, since associated entities can have association to other entities. This is indicated by block 309 in FIG. 4.

Once all of the desired generated class projections have been populated with properties from the user, the tool simply builds the entity projections and deploys them to the requesting service, in this case service B. This is indicated by block 310 in FIG. 4. Service B then stores the data, the projection encapsulates, in its local data store 208. This is indicated by block 312 in FIG. 4.

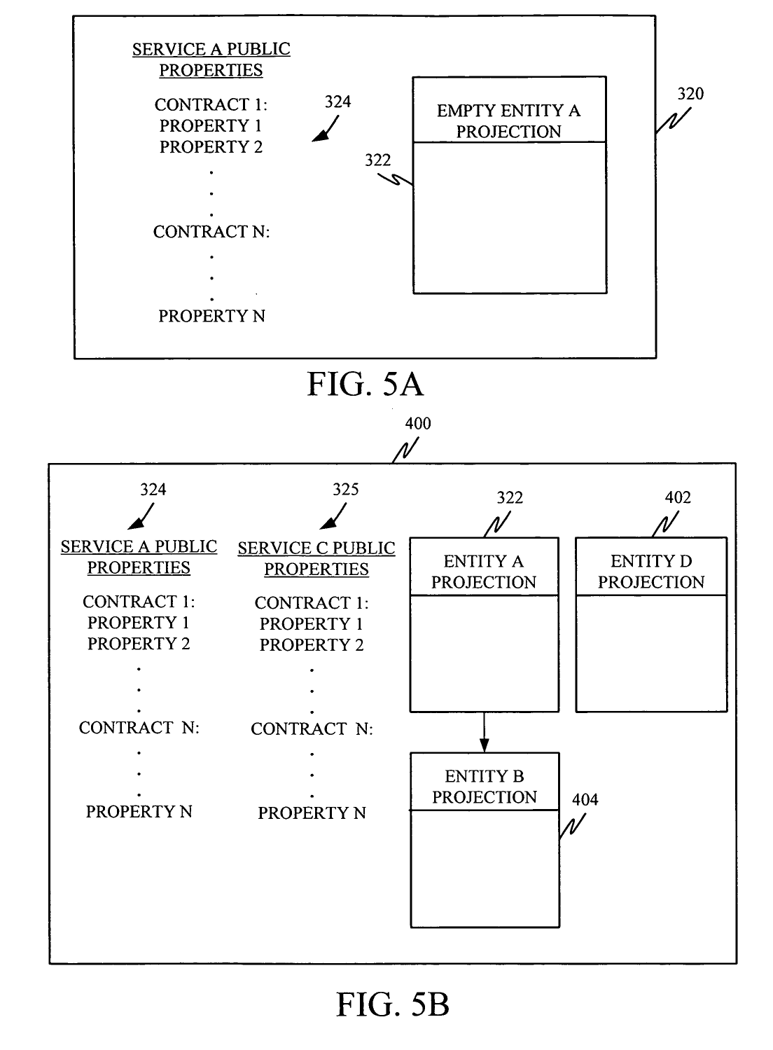

FIG. 6 illustrates a more concrete embodiment of the present invention. FIG. 6 shows accounts receivable service 502 and sales service 504. Accounts receivable service 502 has a plurality of entities represented by a UML diagram. Accounts receivable service 502 includes a customer entity 506 that has a composition of addresses represented by address entity 508. Customer entity 506 is shown with a plurality of properties that represent a customer. Of course, in an actual application, there may be a very large number of properties, perhaps in excess of 100 properties in a customer entity 506. Address entity 508 is associated with customer entity 506 and is also shown with a plurality of properties, but may in actuality have as many as 50 or more properties.

Sales service 504 is also shown with a plurality of entities represented in a UML diagram. Sales service 504 includes an order entity 510 and a composition of order line entities 512. It can be seen from the UML diagram that order entity 510 in sales service 504 requires a reference to the customer entity 506 in accounts receivable service 502. However, instead of directly referencing that entity in accounts receivable service 502, tool 220 has created customer projection 514. Only the required properties and the properties desired by sales service 504 are populated into projection 514. Therefore, order entity 510 in sales service 504 hold an association to the customer projection 514 which is also local to the sales service 504.

FIG. 6 also shows that order line entity 512 has an association to the address entity. However, instead of directly referencing address entity 508 in accounts receivable services 502, tool 220 has set up address projection 516 in sales service 504. Both projections 514 and 516 are stored in the data store locally used by sales service 504. Therefore, projections 514 and 516 look as if they are locally owned entities, even though they are actually owned by a separate service.

FIG. 6 also shows that order line entity 512 has an association to the item projection 518. In one illustrative embodiment, item projection 518 is an entity projection that comes from a service different from projections 514 and 516, which come from accounts receivable service 502. In an illustrative embodiment, projection 518 comes from an inventory service, for example.

It will be noted that the entities and entity projections shown and discussed with respect to the present invention, as is generally known, have functionality that enables them to load and persist information from a database, and they are not simply object classes with a few properties. Instead, as is known, entities are much richer.

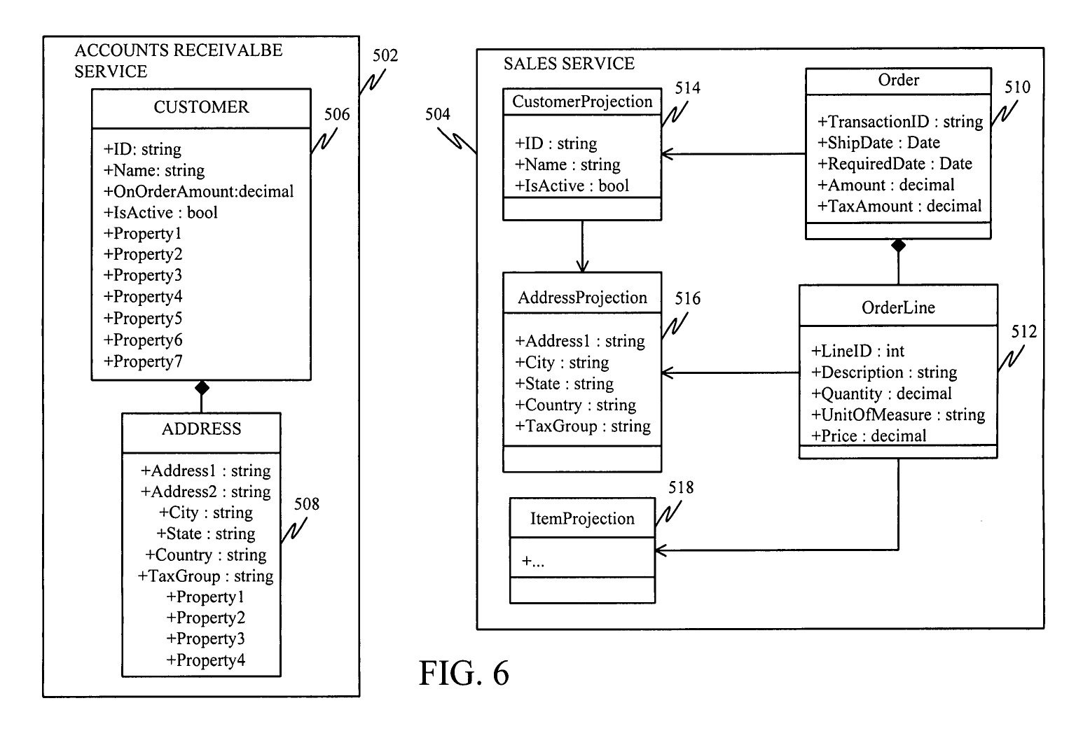

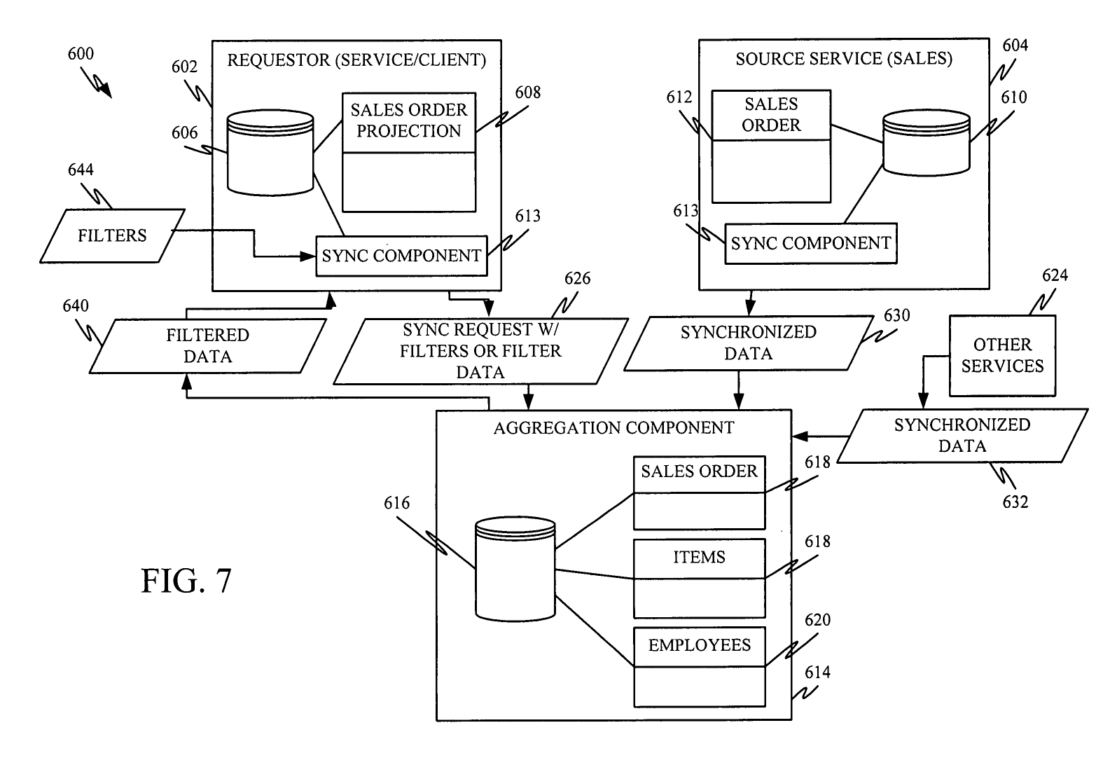

Once the entity projections are created as discussed above, they can be used as a programming construct to access data synchronized to the data store associated with the consumer (such as data store 208 in FIG. 3B). The data store 208 must first be populated with this data, and then changes, additions or deletions to that data must be synchronized to the consuming service as well. As discussed with respect to FIGS. 7 and 8 below, it may be desirable to provide a filtering mechanism during initial population and synchronization. Again, the filtering mechanism of the present invention is not to be limited to filtering data synchronized to the data store and accessed through entity projections, but can also be used to filter data accessed through entities as well. It is described here in the context of an entity projection for the sake of example only.

FIG. 7 shows a system 600 that illustrates how filters are applied to data during initial population and synchronization in accordance with one embodiment of the present invention

System 600 includes a requester 602 which may be a service or another client. System 600 also includes an owning service 604, such as a sales service that deals with processing sales orders and the like. Requestor 602 includes a local data store 606 that contains entities, and possibly entity projections. FIG. 6 shows that requestor 602 includes a sales order entity projection 608. Owning service 604 also includes a data store 610 that contains entities and possibly entity projections. FIG. 6 shows that service 604 owns sales order entities 612 and thus they are stored on data store 610. It can thus be seen that client 602 needs access to a synchronized copy of the data in sales order entities 612 stored on owning service 604.

In order to obtain this access, a subset of the data from sales order entity 612 is synchronized to requester 602 through aggregation service 614. Therefore, each of the requestors and services in system 600 illustratively include a synchronization (sync) component 613. Synchronization components 613 interact with aggregation service 614 to perform the steps necessary to transmit synchronization requests from requesters to aggregation service 614 and to handle returned data from aggregation service 614 in response to synchronization requests. The specific way the synchronization components 613 operate is not important for purposes of the present invention, other than to say that they are configured to handle the transmission of requests, filters (or data from which filters can be discerned), and the receipt of information in response to those requests.

Aggregation service 614, itself, includes an internal data store 616 that contains information from a wide variety of different owning services, which is to be synchronized to various consumers. In the embodiment shown in FIG. 6, data store 616 includes sales order entities 618 owned by sales service 604, item entities 620 which might be, for instance, owned by an inventory service, and employee entities 622 which might be, for example, owned by a human resources service. The various services not specifically identified, from which aggregation service 614 can receive data is represented by other services 624.

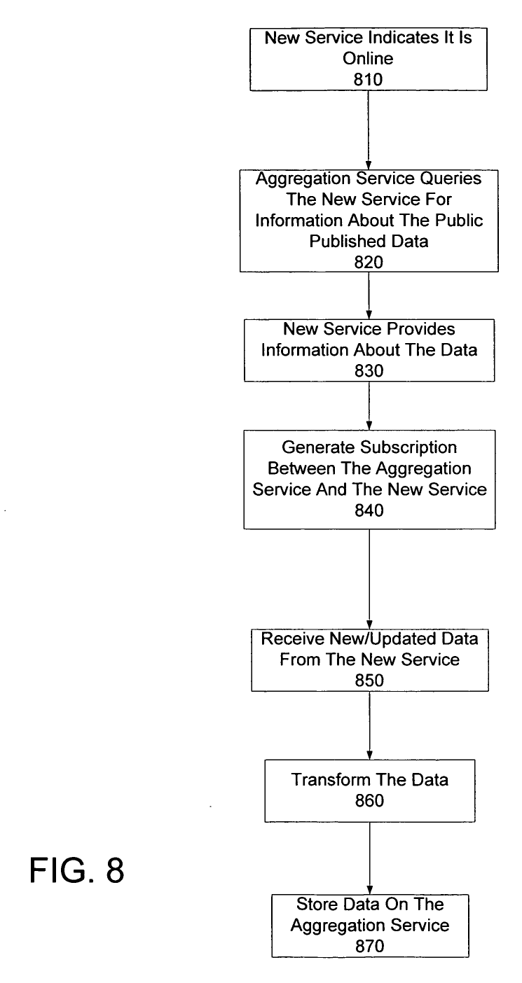

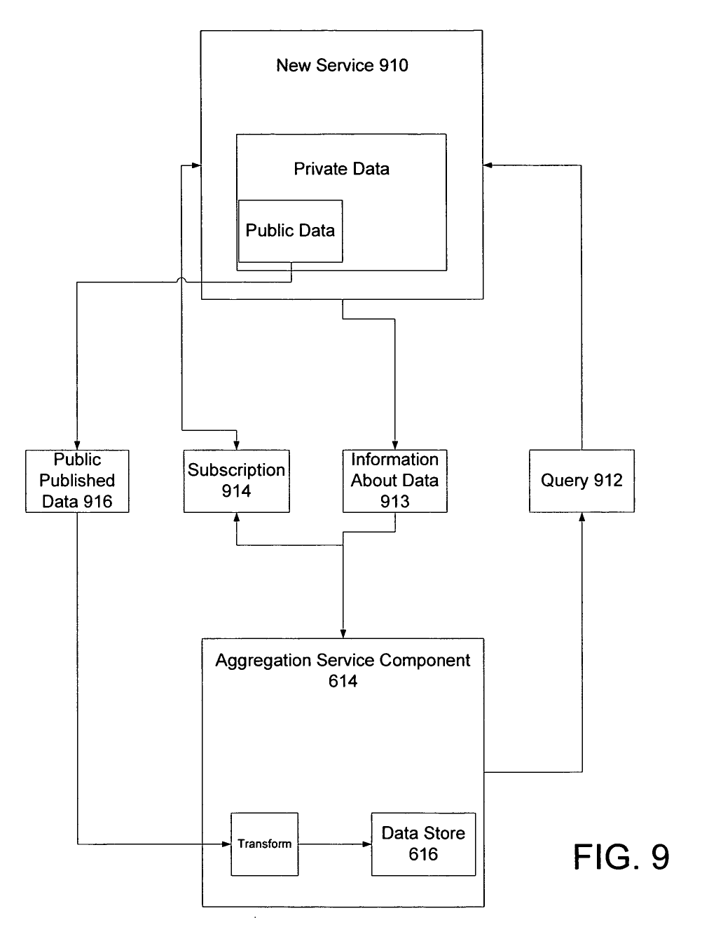

The aggregation service 614 will provide data changes to any service that has been registered with it. In order for aggregation service 614 to provide data to any given service, the service needs to register with aggregation service 614 that it will provide creates, updates, and deletes of certain data The aggregation service 614 is populated with public data that is made available to it from the services that are present in the system, and that have registered with the aggregation service. The registration of each service can occur in a number of ways. FIG. 8 illustrates the steps that are executed to register a service with the aggregation service. FIG. 9 illustrates one example of the process. FIGS. 8 and 9 will be discussed together.

There are four steps to the registration of a service with the aggregation service. Depending on the policy and system configuration, the aggregation service 614 can be populated in one of three ways: (1) push, (2) pull, or (3) shared data store. By push, it is meant that the aggregation service 614 receives the desired application data from the new service 910. For example, this is done by the aggregation service subscribing to data creation, change, and deletion events published by the new service. By pull it is meant that the aggregation service 614 pulls the application data from the new service 910 at a scheduled, recurrent time interval, and by shared data store it is meant that the aggregation service 614 shares the application data with the new service 910 by using the same data store. For purposes of this discussion it is assumed that the aggregation service 614 uses pull to retrieve its data.

The first step is determining existence of a service which can be done in one of two ways, explicit notification and discovery. This is illustrated at step 810 of FIG. 8. A service 910 can make its existence known to the aggregation service 614 by explicitly notifying the aggregation service 614 in a manner that has been predetermined by the developer. In one approach the new service 910 is attempting to register itself with the aggregation service 614. Alternatively, discovery is where the aggregation service queries the network to see if there are any new service online, and if so, registers them.

Once the new service 910 has made its existence known, the aggregation service must retrieve metadata from the new service 910. This is illustrated at step 820. This query contains a series of requests for metadata from the new service. In one embodiment, the aggregation service 614 requests metadata about the service. An example of this metadata is the data contracts the service exposes. However, other types of requests can be made by the aggregation service.

Once the request is received the new service 910 responds to the request by transmitting to the aggregation service 614 the requested metadata 913. This is illustrated at step 830.

The next step in the registration process is setting up how the aggregation service will be populated with application data. If push synchronization will be used, the aggregation service 614 attempts to create subscriptions 914 to the new service. These subscriptions 914 notify the service 910, which owns the data, to send data updates to the aggregation service 614. The subscription is created at step 840.

The data can be sent back at various intervals. In one embodiment, the interval is a predetermined period of time, such as every hour. In another embodiment the interval is after a predetermined number of new changes have been made, such as 10 changes. In yet another embodiment, the updates occur instantaneously. In other words any time there is a change in the data at the new service 910, the aggregation service 614 is updated.

In another embodiment where pull synchronization is used, a request from the aggregation service 614 to be updated by the new service 910 is made (at that point in time).

In yet another embodiment, if a shared data store is used by the service 910 and the aggregation service 614, this step is not needed, as the changes will be reflected real-time.

Once the data population configuration is complete at step 840, the last step is where the aggregation service 614 receives the data 916 that is published, from the new service 910. If synchronizing via push, an initial load of data is required to retrieve all existing data from the new service 910. If synchronizing via pull, all of the existing data will be retrieved on the initial scheduled update. In both embodiments, this data 916 is received by the aggregation service 614 as a message conforming to a predefined contract schema. In one embodiment the contract schema is in XSD. However, other forms can be used for the contract schema. The receipt of the data is illustrated at step 850.

Following the receipt of the data at the aggregation service 614, the data may be transformed before persisting it in the aggregation service's 614 data store. The transformation of data is illustrated at step 860.

Following any transformations that are made, the aggregation service 614 proceeds to store the data in the local store 616 along with any of the associated metadata information that was also provided by the new service. The storing of the data at the aggregation service is illustrated at step 870.

Although the present invention has been described with reference to particular embodiments, workers skilled in the art will recognize that changes may be made in form and detail without departing from the spirit and scope of the invention.

What is claimed is:

1. A method for registering a service with an aggregation service, comprising:
determining that the service is ready to register with the aggregation service;
obtaining metadata related to the new service;
obtaining existing data from the service; and
storing that existing data at the aggregation service.

2. The method of claim 1 further comprising:
generating subscriptions between the aggregation service and the new service.

3. The method of claim 2 wherein the subscriptions includes information related to the type of data and when it will be updated.

4. The method of claim 2 further comprising:
updating the data using the subscription.

5. The method of claim 3 wherein the update occurs at a predetermined time interval.

6. The method of claim 3 wherein the update occurs after a predetermined number of changes have occurred.

7. The method of claim 3 wherein the update occurs after each data change in the new service.

8. The method of claim 1 wherein determining comprises:
receiving a message from the service indicating that it is ready to register.

9. The method of claim 1 wherein determining comprises:
querying the network to determine if there are new services to be registered.

10. The method of claim 1 wherein obtaining metadata comprises:
querying the service for the metadata.

11. The method of claim 1 wherein obtaining metadata comprises:
receiving the metadata from the service.

12. The method of claim 1 wherein obtaining data comprises:
querying the new service for the data; and
receiving the data from the new service.

13. The method of claim 2 wherein generating a subscription comprises:
receiving a subscription request from the aggregation service; and
receiving a confirmation from the new service.

14. The method of claim 2 wherein generating a subscription comprises:
receiving subscription information from the new service at the aggregation service.

15. A computer readable medium configured with computer executable instructions to register a service with an aggregation service that when executed cause a computer to:
determine that the service is ready to register with the aggregation service;
obtain metadata for service public data;
obtain existing data from the service; and
store the existing data at the aggregation service.

16. The computer readable medium of claim 15 further including instructions to:
generate a subscription between the aggregation service and the new service.

17. The computer readable medium of claim 16 further including instructions to:
update the data in the aggregate service using the subscription.

18. The computer readable medium of claim 15 wherein the medium is further configured to:
receive a message from the service indicating that it is ready to register.

19. The computer readable medium of claim 18 wherein the medium is further configured to:
send a query to the service.

20. The computer readable medium of claim 15 wherein the medium is further configured to:
query the service for the data; and
receive the data from the new service.
